(19) United States
(12) Patent Application Publication
(10) Pub. No.: US 2026/0020058 A1
(43) Pub. Date: Jan. 15, 2026

(54) SYSTEM AND METHOD FOR JOINT MEDIUM ACCESS AND TRANSMIT OPPORTUNITY SHARING IN WIRELESS LOCAL AREA NETWORKS

(71) Applicant: Samsung Electronics Co., Ltd., Gyeonggi-do (KR)

(72) Inventors: Yongsen MA, Milpitas, CA (US); Michail KOUNDOURAKIS, Hamburg (DE); Mark Gorthorn RISON, Cambridge (GB); Srinivas KANDALA, Morgan Hill, CA (US); Ravi GIDVANI, Fremont, CA (US)

(21) Appl. No.: 19/255,338

(22) Filed: Jun. 30, 2025

Related U.S. Application Data
(60) Provisional application No. 63/670,025, filed on Jul. 11, 2024.

(51) Int. Cl. H04W 74/0808; H04W 84/12

(52) U.S. Cl. CPC H04W 74/0808; H04W 84/12

(57) ABSTRACT

A method and system for wireless communication in a wireless local area network (WLAN) are disclosed. The method includes obtaining, by a non-access point (non-AP) station (STA), access to a wireless medium based on a contention-based channel access procedure; initiating, by the non-AP STA, upon obtaining access to the wireless medium, a transmit opportunity (TXOP); transmitting, by the non-AP STA, a control frame to a second STA during the TXOP; and receiving, by the non-AP STA, one or more physical layer protocol data units (PPDUs) from the second STA in accordance with scheduling information in the control frame.

### CROSS-REFERENCE TO RELATED APPLICATION

This application claims the priority benefit under 35 U.S.C. § 119(e) of U.S. Provisional Application No. 63/670,025, filed on Jul. 11, 2024, the disclosure of which is incorporated by reference in its entirety as if fully set forth herein.

### TECHNICAL FIELD

The disclosure generally relates to wireless local area network (WLAN) communications. More particularly, the subject matter disclosed herein relates to improvements to medium access and transmit opportunity (TXOP) sharing mechanisms, including techniques that enable joint access coordination and TXOP sharing among a group of stations (STAs).

### SUMMARY

WLANs, such as those based on the Institute of Electrical and Electronics Engineers (IEEE) 802.11 standard, rely on distributed channel access mechanisms to coordinate communications among STAs. Both access points (APs) and non-AP STAs attempt to gain medium access through enhanced distributed channel access (EDCA), which is based on carrier sense multiple access (CSMA) with collision avoidance (CA). Once an STA obtains access, it may be granted a transmit opportunity (TXOP) during which the STA may transmit one or more frames. However, in group-based or dense network environments, where multiple STAs attempt to communicate with each other or with the AP, traditional medium access procedures may lead to redundant contention, collisions, or underutilized TXOPs due to a lack of coordination across devices.

To address this problem, various TXOP sharing techniques have been proposed. These include triggered TXOP sharing (TXS), reverse direction grant (RDG), and multi-user TXS, which allow an AP that obtains a TXOP to coordinate transmissions involving one or more non-AP STAs. For example, the AP may send a trigger frame to initiate uplink transmissions or allow a TXOP responder to perform peer-to-peer (P2P) transmissions. These solutions aim to improve efficiency by aggregating traffic and reducing contention among multiple users.

One issue with the above approach is that TXOP sharing is typically initiated by the AP, creating a dependency on centralized scheduling. In scenarios involving P2P communication, relay-based forwarding, or situations where a non-AP STA is waiting to retrieve downlink data from the AP, this centralized model can introduce avoidable delays. Furthermore, when multiple STAs are part of a coordinated group, such as in multi-link, mesh, or multi-AP deployments, contention among group members can result in wasted TXOPs and increased collisions.

To overcome these types of issues, systems and methods are described herein for joint medium access and TXOP sharing initiated by non-AP STAs. In the disclosed approach, a non-AP STA may independently obtain a TXOP and either initiate transmissions within a group or delegate the TXOP to another STA, such as a designated group leader. These coordination procedures may involve control messages such as trigger frames, polling frames, or initial control frames (ICFs). The techniques support dynamic traffic coordination, including uplink, downlink, and P2P transmissions, and allow non-AP STAs to request downlink data from the AP by initiating the medium access themselves. Additionally, TXOP sharing may also be initiated by an AP and shared with multiple STAs, including other AP(s), non-AP STA(s), and relay STA(s), enabling various forms of transmission coordination within the group.

The above approaches improve on previous methods because they reduce dependence on centralized control by the AP and increase flexibility in how TXOPs are acquired and shared. As a result, channel utilization improves and the system scales more effectively across WLAN configurations such as multi-link devices, mesh topologies, and collaborative group transmissions.

According to an embodiment, a method for wireless communication in a WLAN is provided. The method includes obtaining, by a non-AP STA, access to a wireless medium based on a contention-based channel access procedure; initiating, by the non-AP STA, upon obtaining access to the wireless medium, a TXOP; transmitting, by the non-AP STA, a control frame to a second STA during the TXOP; and receiving, by the non-AP STA, one or more physical layer protocol data units (PPDUs) from the second STA in accordance with scheduling information in the control frame.

According to another embodiment, a non-AP STA for wireless communication in a WLAN is provided. The non-AP STA includes a processor configured to obtain access to a wireless medium based on a contention-based channel access procedure; initiate a TXOP upon obtaining access to the wireless medium; transmit a control frame to a second STA during the TXOP; and receive one or more PPDUs from the second STA in accordance with scheduling information in the control frame.

According to another embodiment, a method for wireless communication in a WLAN is provided. The method includes obtaining, by an AP, access to a wireless medium based on a contention-based channel access procedure; initiating, by the AP, upon obtaining access to the wireless medium, a TXOP; transmitting, by the AP, a control frame to a group of STAs, the group comprising at least one of another AP, a non-AP STA, or a relay STA; and coordinating, by the AP, transmissions with the group of STAs during the TXOP based on scheduling information included in the control frame.

### BRIEF DESCRIPTION OF THE DRAWING

In the following section, the aspects of the subject matter disclosed herein will be described with reference to exemplary embodiments illustrated in the figures, in which:

FIG. 1 is a network architecture illustrating TXOP sharing initiated by a non-AP STA, according to an embodiment;

FIG. 2 is a signaling diagram of TXOP sharing initiated by a non-AP STA using a trigger-based mechanism, according to an embodiment;

FIG. 3 is a signaling diagram of TXOP sharing initiated by a non-AP STA using an ICF, according to an embodiment;

FIG. 4 is a signaling diagram of TXOP sharing initiated by a non-AP STA using an ICF, according to an embodiment;

FIG. 5 is a signaling diagram of TXOP sharing initiated by an AP using multi-user request-to-send (MU-RTS) TXS, according to an embodiment;

FIG. 6 is a flowchart illustrating a method for joint medium access and TXOP sharing in a WLAN, according to an embodiment;

FIG. 7 is a block diagram of an electronic device in a network environment, according to an embodiment; and

FIG. 8 is a system including a non-AP STA and an AP, in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“STA” as used herein refers to a station capable of transmitting and receiving data in a wireless local area network (WLAN). Some examples of an “STA” are APs, non-APs, laptops, smartphones, tablets, or other wireless-enabled devices compliant with IEEE 802.11 standards.

“AP” as used herein refers to an access point that provides connectivity, scheduling, and coordination services to one or more non-AP STAs within a basic service set (BSS). Some examples of an “AP” are wireless routers, wireless controllers, and mesh network coordinators.

“Non-AP STA” as used herein refers to a station that is not an AP and that may rely on an AP for network association, access control, and coordination. Some examples of a “non-AP STA” are client devices such as smartphones, laptops, Internet of things (IoT) sensors, or tablets that connect to the WLAN.

“TXOP” as used herein refers to a transmit opportunity, which is a defined time interval during which a station that has gained access to the wireless medium is permitted to transmit one or more data or control frames without needing to recontend for the medium. Some examples of “TXOP” include time intervals obtained by an STA via EDCA or granted by an AP through a trigger-based scheduling mechanism.

“TXOP holder” as used herein refers to an STA that has successfully gained access to the wireless medium and has control over the use of the TXOP during a given time interval. An example of “TXOP holder” includes a non-AP STA that has obtained the TXOP and is coordinating transmissions within a group.

“Wireless medium” (also referred to as “medium”) as used herein refers to the shared wireless communication channel over which STAs transmit and receive data using electromagnetic signals. Some examples of “wireless medium” are the 2.4 gigahertz (GHz) and 5 GHz unlicensed frequency bands used by IEEE 802.11 WLANs, as well as the 6 GHz band in Wi-Fi 6E.

“Contention-based channel access procedure” as used herein refers to a process by which multiple STAs independently attempt to access the wireless medium by sensing channel availability. Some examples of “contention-based channel access procedure” include carrier sense multiple access with collision avoidance (CSMA/CA) and EDCA as defined in IEEE 802.11 standards.

“PPDU” as used herein refers to a physical layer protocol data unit, which is the complete data frame that is transmitted over the wireless medium at the physical layer in accordance with the IEEE 802.11 standard. Some examples of “PPDU” include data frames, control frames, or acknowledgment frames that have been formatted and encoded for transmission over the air, including components such as preamble, header, and payload.

The present disclosure provides enhancements in medium access and TXOP sharing procedures for WLANs. In some IEEE 802.11 systems, both APs and non-AP STAs contend for access to the wireless medium using contention-based channel access procedures. Once an STA gains access, it may be allocated a TXOP, during which it can transmit one or more frames. Existing mechanisms allow uplink, downlink, and P2P traffic to be supported within a single TXOP using techniques such as TXS, RDG, and multi-user cascading. For example, when an AP obtains a TXOP, it may initiate downlink transmissions to STAs, send a trigger frame to initiate uplink transmissions, or use TXS to allow a non-AP STA to send uplink or P2P data (as a TXOP responder) in sharing mode 1 or sharing mode 2, respectively. Similarly, when a non-AP STA obtains a TXOP, it may use it to initiate uplink transmissions to the AP or P2P transmissions with another STA, and in some cases may employ RDG to prompt the AP to respond with downlink data.

Various proposals may extend TXOP sharing capabilities for broader multi-user uplink, downlink, and P2P traffic scenarios. These may include mechanisms in which the AP, after obtaining a TXOP, may share it with multiple STAs using MU-RTS TXS or related approaches, or advertise P2P transmission opportunities by providing timing and channel information for coordinated group activity. Other enhancements may focus on allowing non-AP STAs to share their own TXOPs. For example, a non-AP STA may initiate transmission coordination for P2P or uplink/downlink (UL/DL) traffic, may engage in reverse TXOP sharing with the AP, or may act as the initiator of TXOP sharing procedures altogether.

The systems and methods described herein may enable non-AP STAs to not only participate in, but also initiate, joint medium access and TXOP sharing across groups of STAs. These techniques support flexible, semi-distributed scheduling in which any STA within a group may obtain medium access and either coordinate transmissions directly or transfer the TXOP to a group leader for further coordination. This model improves upon conventional AP-driven mechanisms by reducing in-group contention and enabling responsive scheduling in various environments, including relay, proxy, mesh, soft AP, and multi-AP deployments. The following sections provide further details regarding system architecture and signaling behavior.

In accordance with various embodiments, TXOP sharing may be performed within a group of STAs, where at least two STAs are involved in coordinated communication. Either an AP or a non-AP STA may act as the TXOP holder and may share the TXOP with one or more APs or non-AP STAs to initiate various types of transmissions. When a non-AP STA holds the TXOP, it may designate either another non-AP STA or an AP as the TXOP responder. In such cases, the responder may utilize the shared TXOP to initiate transmissions with the original TXOP holder, with additional non-AP STAs, or with other APs.

For example, when the TXOP responder is an AP, the AP may perform downlink, uplink, or AP-to-AP transmissions involving other STAs. If the TXOP responder is a second non-AP STA, it may similarly initiate transmissions with the original non-AP STA, with other peer STAs, or with the AP. Additionally, the non-AP STA holding the TXOP may coordinate with multiple non-AP STAs within the same TXOP interval, thereby enabling more efficient group-based communication. Likewise, when the AP is the TXOP holder, it may share the TXOP with one or more AP or non-AP STAs, enabling transmission types such as downlink, uplink, P2P, tunneled direct link setup (TDLS), or relay-based communication across a broad range of participants.

Accordingly, the present disclosure allows non-AP STAs to initiate TXOPs and to serve as active participants in medium access coordination. These capabilities are useful in group-based deployments such as P2P communication, relay forwarding, proxy-assisted transmission, mesh networking, soft AP configurations, and multi-AP environments. In addition to supporting intra-group coordination, the proposed approach allows non-AP STAs to actively retrieve downlink data from the AP, rather than relying solely on AP-initiated transmissions. While the system supports non-AP STA-initiated procedures, it also encompasses cases where the AP functions as the TXOP holder and initiates transmissions, including AP-to-AP or P2P traffic exchanges.

In addition, the proposed architecture introduces joint medium access and TXOP sharing techniques, in which a non-AP STA may transmit a trigger frame, polling frame, or ICF to initiate a group-based transmission exchange. The TXOP may be shared with another non-AP STA or with the AP. This enables non-AP STAs to initiate medium access for retrieving downlink data from the AP or conducting P2P transmissions, and to support downlink, uplink, and P2P traffic within the same TXOP interval. In group scenarios, the medium access procedure may be initiated by any STA, with coordination managed through trigger-based access or TXOP sharing. Each STA in the group may contend for the medium using CSMA or EDCA. If a group leader obtains the TXOP, it may initiate transmissions by sending a trigger or polling frame to peer STAs. Alternatively, if a different STA acquires the TXOP, it may transfer or share it with the group leader, who then coordinates the transmission schedule. A non-AP STA may also obtain a TXOP specifically to retrieve pending downlink data from the AP, based on conditions such as its reception or Layer 2 (L2) buffer status. In such cases, the non-AP STA may queue a request, trigger, or polling frame to signal its interest in receiving downlink data, without requiring the AP to initiate access first.

The techniques described herein do not require the AP to initiate or manage the acquisition of the TXOP, thereby reducing complexity at the AP and offloading certain scheduling responsibilities to non-AP STAs. Accordingly, the AP is not required to determine when or how to share its own TXOP, nor is it necessary for the AP's TXOP, acquired through contention with other STAs, to be repurposed for use by non-AP devices. Additionally, non-AP STA transmissions can operate independently, without reliance on AP coordination, reducing dependence on centralized control.

This approach expands the available options for medium access in group-based STA configurations and is designed to coexist seamlessly with existing access mechanisms such as EDCA, trigger-based access, TXS, and multi-STA TXOP sharing, and helps avoid in-group contention and redundant backoff procedures that may arise when both inter-group and intra-group STAs independently contend for the channel, minimizing wasted TXOP intervals. Medium access under the proposed architecture may be semi-distributed: in some cases, STAs operate in a fully distributed fashion using EDCA independently, while in other cases, scheduling is coordinated using trigger frames, polling frames, or ICFs. This hybrid model allows the system to respond more quickly to high-priority traffic and supports efficient grouping of downlink, uplink, and P2P transmissions within a single TXOP. In addition, the approach may scale effectively across a variety of complex deployment scenarios, including multi-link, multi-basic service set (BSS), and multi-AP environments.

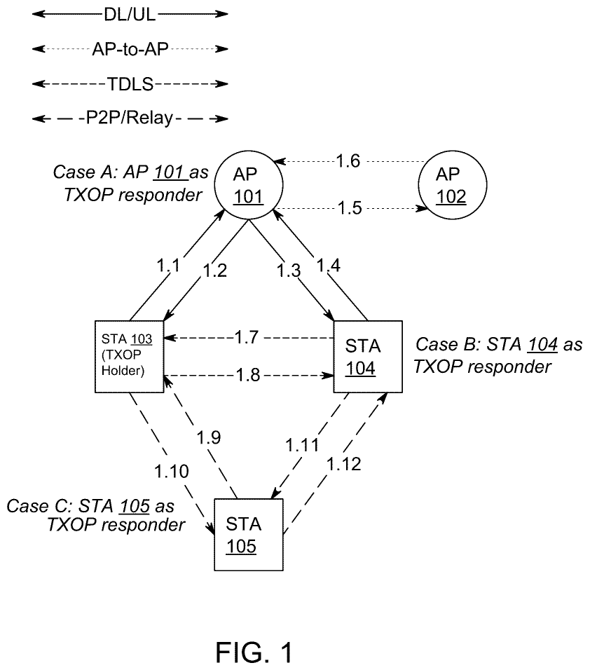

FIG. 1 is a network architecture illustrating TXOP sharing initiated by a non-AP STA, according to an embodiment.

Referring to FIG. 1, AP 101, AP 102, STA 103, STA 104, and STA 105 are shown. STA 103 is the TXOP holder, which is the STA that has successfully obtained access to the wireless medium and holds the TXOP.

FIG. 1 illustrates three cases, each case representing a different TXOP responder, namely, AP 101 in Case A, STA 104 in Case B, and STA 105 in Case C. Accordingly, the TXOP may be shared with various responders to enable downlink, uplink, P2P, AP-to-AP, or relay transmissions within the same TXOP interval.

In Case A, AP 101 is the TXOP responder. As shown by arrow 1.1, STA 103 shares the TXOP with AP 101. Upon receiving the shared TXOP, AP 101 may initiate several types of transmissions. As illustrated by arrow 1.2, AP 101 may transmit downlink data to STA 103, which can be similar to the use of RDG. Additionally, AP 101 may initiate downlink and uplink transmissions involving STA 104, as shown by arrows 1.3 and 1.4, respectively. This may be beneficial in proxy-based use cases, such as in virtual reality (VR), augmented reality (AR), or extended reality (XR) applications. Furthermore, AP 101 may use the shared TXOP to perform AP-to-AP transmission and reception with AP 102, as shown by arrows 1.5 and 1.6, respectively, which may be applicable in multi-AP or mobile AP scenarios.

In Case B, STA 104 is the TXOP responder. STA 103, as the TXOP holder, shares the TXOP with STA 104, as indicated by arrow 1.8. STA 104 may then use the TXOP to initiate transmissions with STA 103 (arrows 1.7 and 1.8), with STA 105 (arrows 1.11 and 1.12), or with AP 101 (arrows 1.3 and 1.4). Accordingly, in Case B, a peer STA may take control of the TXOP and act as a coordinating participant in various transmission patterns across the group.

In Case 3, STA 105 is the TXOP responder. As shown by arrow 1.10, STA 103 shares the TXOP with STA 105. Once the TXOP is transferred, STA 105 may initiate transmissions with STA 103 (arrows 1.9 and 1.10) or with STA 104 (arrows 1.11 and 1.12), enabling flexible P2P or relay communication. Accordingly, FIG. 1 shows the case where STA 103 is the initial TXOP holder, and the same principles apply if any other device, such as AP 101, AP 102, STA 104, or STA 105, were to be the TXOP holder by obtaining the TXOP and sharing it with another STA or AP.

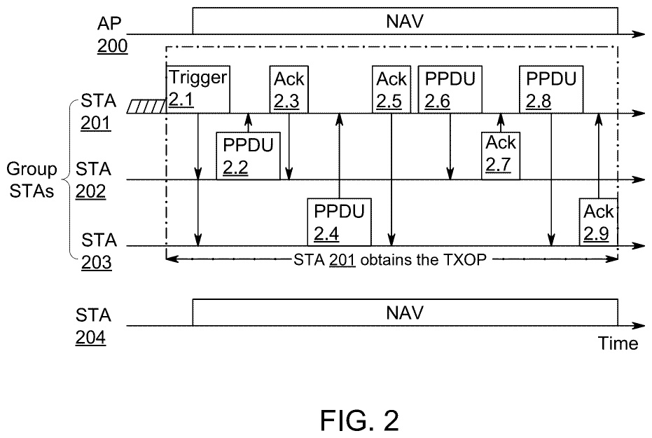

FIG. 2 is a signaling diagram of TXOP sharing initiated by a non-AP STA using a trigger-based mechanism, according to an embodiment.

Referring to FIG. 2, STA 201 obtains access to the medium and becomes the TXOP holder. Upon obtaining the TXOP, STA 201 transmits a trigger frame to STA 202 and STA 203, which may also include polling information if needed, in block 2.1. The trigger frame serves to coordinate the uplink transmissions within the group. In response to the trigger, STA 202 transmits its PPDU to STA 201 in block 2.2, and STA 201 responds with an acknowledgement (ACK) frame in block 2.3; and STA 203 transmits its PPDU to STA 201 in block 2.4, and STA 201 responds with an ACK frame in block 2.5. The PPDU transmissions in blocks 2.2 and 2.4 are based on the scheduling information indicated in the trigger from block 2.1. In block 2.6, STA 201 subsequently sends its own PPDU to STA 202, and receives an ACK in block 2.7; sends its own PPDU to STA 203 in block 2.8, and receives an ACK in block 2.9, completing a bidirectional exchange of data within the same TXOP interval.

As shown in the diagram, network allocation vectors (NAVs) are set for the AP 200 and for other external STAs, such as STA 204, allowing the group of participating STAs (201, 202, and 203) to utilize the channel without contention during the TXOP.

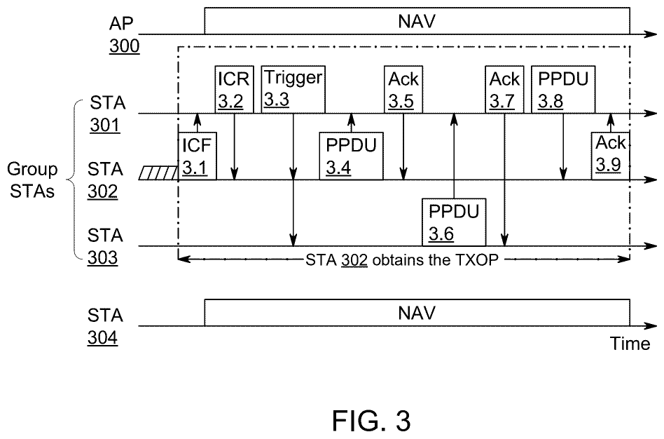

FIG. 3 is a signaling diagram of TXOP sharing initiated by a non-AP STA using an ICF, according to an embodiment.

Referring to FIG. 3, STA 302 obtains access to the medium and becomes the TXOP holder. Upon obtaining the TXOP, in block 3.1, STA 302 sends an ICF to STA 301 to initiate TXOP sharing. This ICF indicates that STA 302 is transferring or delegating control over the TXOP to STA 301. In response, STA 301 transmits an initial control response (ICR) to STA 302 in block 3.2. Next, STA 301 coordinates transmissions by sending a trigger frame to STA 302 and STA 303 in block 3.3.

In block 3.4, STA 302 transmits a PPDU to STA 301, and STA 301 responds with an ACK in block 3.5. In block 3.6, STA 303 transmits a PPDU to STA 301, and STA 301 responds with an ACK in block 3.7. These uplink transmissions are performed based on the scheduling information included in the trigger frames sent in block 3.3. Following these uplink exchanges, STA 301 transmits its own PPDU to STA 302 in block 3.8 and receives an ACK in block 3.9, completing a bidirectional data exchange within the same TXOP interval.

As shown in the diagram, NAVs are set at the AP 300 and other external STAs, such as STA 304, allowing the group of participating STAs (301, 302, and 303) to utilize the channel without contention during the TXOP.

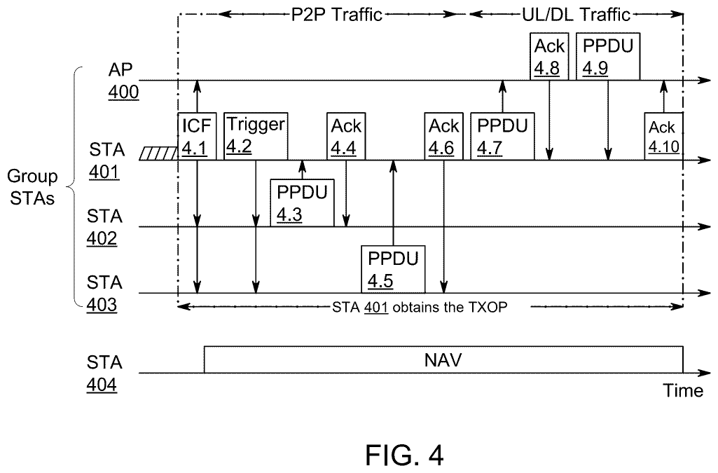

FIG. 4 is a signaling diagram illustrating TXOP sharing initiated by a non-AP STA using an ICF, according to an embodiment.

Referring to FIG. 4, STA 401 obtains access to the wireless medium and becomes the TXOP holder. In block 4.1, STA 401 transmits an ICF to STA 402, STA 403, and AP 400 to initiate TXOP sharing. This ICF may be either solicited or unsolicited, and in some embodiments, it may be integrated with or combined into another frame, such as a trigger or polling frame.

Following the ICF, STA 401 sends a trigger frame to STA 402 and STA 403 in block 4.2 to coordinate P2P transmissions within the group. In block 4.3, STA 402 transmits a PPDU to STA 401, and STA 401 responds with an ACK in block 4.4. In block 4.5, STA 403 transmits a PPDU to STA 401, and STA 401 responds with an ACK in block 4.6. These exchanges represent P2P transmissions within the group of STAs, organized by the TXOP holder.

Subsequently, STA 401 initiates UL/DL communication with the AP 400. In block 4.7, the AP 400 transmits a PPDU to STA 401, and STA 401 responds with an ACK in block 4.8. STA 401 then transmits a PPDU to the AP 400 in block 4.9, and receives an ACK from the AP 400 in block 4.10, completing a bidirectional UL/DL exchange between STA 401 and AP 400.

As shown in the figure, NAVs are set for other external devices such as STA 404, allowing the group of participating STAs (400, 401, 402, and 403) to utilize the channel without contention during the TXOP.

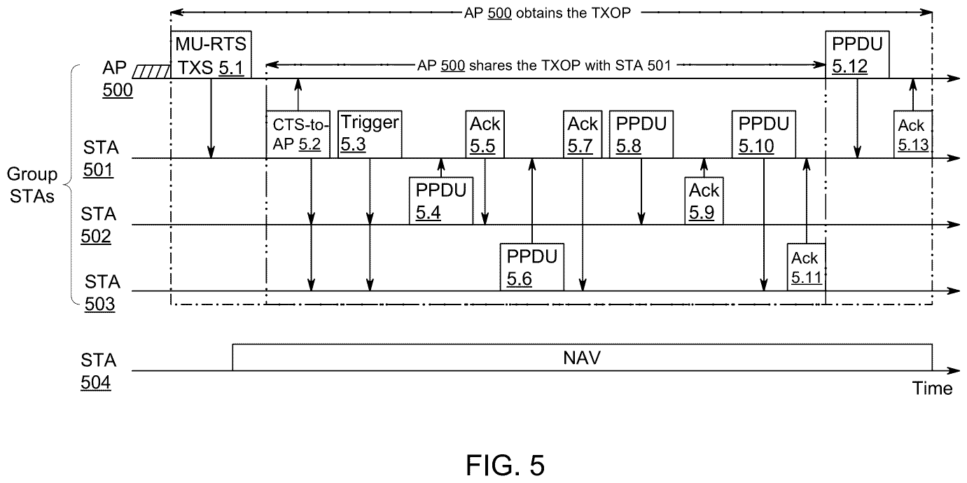

FIG. 5 is a signaling diagram of TXOP sharing initiated by an AP using MU-RTS TXS, according to an embodiment.

Referring to FIG. 5, AP 500 obtains access to the medium and becomes the TXOP holder. In block 5.1, AP 500 transmits an MU-RTS TXS frame to STA 501, thereby initiating the transfer of the TXOP. In block 5.2, STA 501 responds to the MU-RTS TXS with a clear-to-send (CTS-to-AP) frame, confirming the agreement to share the TXOP.

In block 5.3, STA 501 transmits a trigger frame (and polling, if needed) to STA 502 and STA 503 to coordinate uplink transmissions. In block 5.4, STA 502 transmits a PPDU to STA 501, and STA 501 responds with an ACK in block 5.5. In block 5.6, STA 503 transmits a PPDU to STA 501, and STA 501 responds with an ACK in block 5.7. Following these uplink transmissions, STA 501 sends its own PPDUs to STA 502 and STA 503 in blocks 5.8 and 5.10, receiving ACKs in blocks 5.9 and 5.11, respectively, completing the P2P or intra-group data exchanges within the shared TXOP.

After STA 501 completes its group transmissions, AP 500 transmits a PPDU to STA 501 in block 5.12, and STA 501 acknowledges receipt with an ACK in block 5.13. This exchange reflects the remaining portion of the AP's 500 TXOP, scheduled for use after the time allocated to STA 501 in the MU-RTS TXS frame is complete.

As shown in the figure, NAVs are set for other external devices such as STA 504, allowing the group of participating STAs (500, 501, 502, and 503) to utilize the channel without contention during the TXOP.

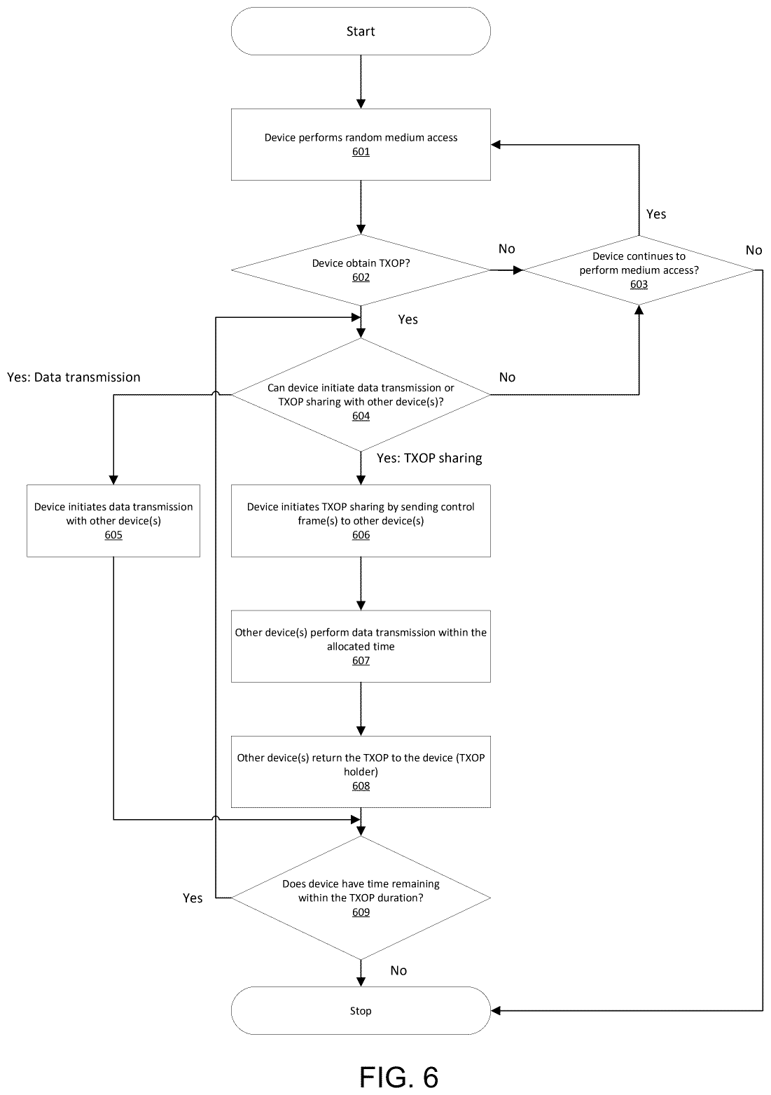

FIG. 6 is a flowchart illustrating a method for joint medium access and TXOP sharing in a WLAN, according to an embodiment. The process may be performed by an electronic device, such as an STA or AP.

The process begins with the device attempting to access the wireless medium using a contention-based channel access procedure, such as EDCA, as shown in step 601.

In step 602, the device determines whether it has successfully obtained a TXOP. If the step does not obtain a TXOP, the process proceeds to step 603, where the device determines whether to continue performing medium access attempts. If the device continues performing medium access attempts, the flow returns to step 601. If not, the process terminates.

If, at step 602, the device successfully obtains a TXOP, the process proceeds to step 604, where the device determines whether it is able to initiate data transmission or initiate TXOP sharing with one or more other devices. This determination may be based on traffic conditions, group coordination logic, or signaling policies.

If the device is configured to initiate data transmission on its own, it may proceed to step 605, where the device initiates a data transmission session with one or more other devices.

Alternatively, if the device is configured to initiate TXOP sharing, the process proceeds to step 606, where the device initiates TXOP sharing by transmitting one or more control frames, such as an ICF or a trigger frame, to one or more other devices. These control frames may indicate a schedule, transmission duration, or resource unit allocation for the TXOP sharing session.

In step 607, the other device(s) that received the control frame(s) may perform their respective data transmissions within the shared TXOP duration. The transmissions may be directed to the TXOP holder, to the AP, or to other peer STAs, and may include uplink, downlink, or P2P data.

In step 608, the TXOP is returned to the original STA that initiated the sharing, referred to as the TXOP holder. The return may occur implicitly based on the end of scheduled time or via an explicit control frame.

In step 609, the device evaluates whether time remains within the originally obtained TXOP duration. If time remains, the flow returns to block 604, allowing the device to either continue transmitting or initiate another TXOP sharing session. If no time remains, the process ends.

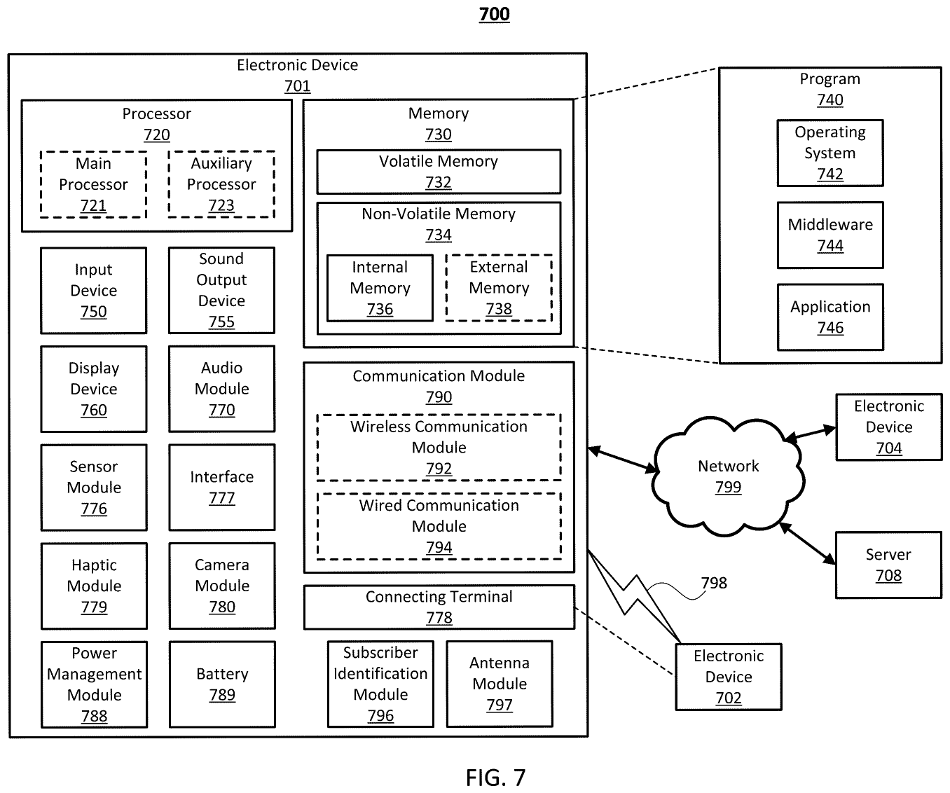

FIG. 7 is a block diagram of an electronic device in a network environment, according to an embodiment.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 740, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 794. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

The communication module 790 may include a wireless transceiver configured to support IEEE 802.11-based communication over one or more frequency bands. In accordance with various embodiments described herein, the communication module 790 may be configured to perform TXOP acquisition and sharing operations. For example, the processor 720 may execute instructions stored in the memory 730 to coordinate the generation and transmission of control frames, such as trigger frames, polling frames, or ICFs, via the communication module 790. These operations may be further supported by the interface 777, which may facilitate interactions between the processor 720 and lower-level radio components, including the antenna module 794, enabling physical-layer signaling compliant with EDCA and CSMA procedures for medium access.

In some embodiments, the processor 720 may also be configured to manage TXOP-related scheduling logic for intra-group transmissions among STAs. This may include determining when to initiate TXOP sharing, when to respond to an ICF or trigger frame, and how to interpret received NAV or ACK signals during group communication. These functions may be integrated into a program 740 executed by the processor 720, and may optionally include logic to determine whether to forward received PPDUs, initiate downlink or uplink transmissions with an AP, or serve as a TXOP holder or responder. The memory 730 may store configuration data, state information for NAV timers, and traffic scheduling policies applicable to P2P, relay, or multi-AP communication scenarios as described in the present disclosure.

As at least part of the data processing or computations, the processor 720 may load a command or data received from another component (e.g., the sensor module 746 or the communication module 790) in volatile memory 732, process the command or the data stored in the volatile memory 732, and store resulting data in non-volatile memory 734. The processor 720 may include a main processor 721 (e.g., a central processing unit (CPU) or an application processor), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, an SCell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

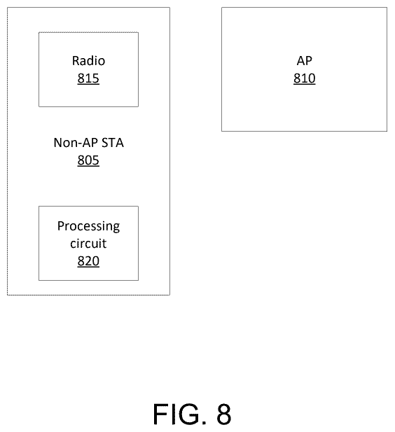

FIG. 8 is a system including a non-AP STA and an AP, in communication with each other, according to an embodiment.

Referring to FIG. 8, the non-AP STA 805 may include a radio 815 and a processing circuit (or a means for processing) 820, which may perform various methods disclosed herein. For example, the processing circuit 820 may receive, via the radio 815, transmissions from an AP (e.g., another STA, network node, satellite, or another electronic device) 810, and the processing circuit 820 may transmit, via the radio 815, signals to the AP 810.

In some embodiments, the non-AP STA 805 may obtain a TXOP using a contention-based channel access procedure, and the processing circuit 820 may generate and transmit control frames, such as trigger frames, polling frames, or ICFs, to initiate or coordinate transmissions within a group of STAs. The radio 815 and processing circuit 820 may also support reception of downlink data from the AP 810 based on such control signaling, and may facilitate TXOP transfers to other STAs or sharing among multiple STAs during a TXOP. Additionally, the AP 810 may also act as a TXOP holder and may initiate sharing of the TXOP with a group of STAs, such as non-AP STAs, relay STAs, or other APs, to enable coordinated uplink, downlink, or P2P transmissions.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for wireless communication in a wireless local area network (WLAN), the method comprising:
obtaining, by a non-access point (non-AP) station (STA), access to a wireless medium based on a contention-based channel access procedure;
initiating, by the non-AP STA, upon obtaining access to the wireless medium, a transmit opportunity (TXOP);
transmitting, by the non-AP STA, a control frame to a second STA during the TXOP; and
receiving, by the non-AP STA, one or more physical layer protocol data units (PPDUs) from the second STA in accordance with scheduling information in the control frame.

2. The method of claim 1, wherein the control frame comprises at least one of a trigger frame, a polling frame, or an initial control frame (ICF).

3. The method of claim 1, wherein the TXOP is shared among a group of STAs, the group comprising the non-AP STA and at least two additional STAs, including the second STA.

4. The method of claim 1, further comprising:
receiving, by the non-AP STA, a request to retrieve downlink data from an access point (AP); and
adding, by the non-AP STA, an additional control frame to a transmit queue to obtain a TXOP for receiving the downlink data.

5. The method of claim 1, further comprising:
determining, by the non-AP STA, whether to initiate the TXOP based on a receive (RX) buffer status or link layer (L2) buffer status.

6. The method of claim 1, wherein the control frame is transmitted by the non-AP STA to an additional non-AP STA designated as a group leader, and the group leader transmits an additional control frame to initiate transmissions with other STAs.

7. The method of claim 1, further comprising:
transferring, by the non-AP STA, the TXOP to a group leader STA.

8. The method of claim 1, wherein the contention-based channel access procedure comprises at least one of carrier sense multiple access (CSMA) or enhanced distributed channel access (EDCA).

9. A non-access point (non-AP) station (STA) for wireless communication in a wireless local area network (WLAN), the non-AP STA comprising a processor configured to:
obtain access to a wireless medium based on a contention-based channel access procedure;
initiate a transmit opportunity (TXOP) upon obtaining access to the wireless medium;
transmit a control frame to a second STA during the TXOP; and
receive one or more physical layer protocol data units (PPDUs) from the second STA in accordance with scheduling information in the control frame.

10. The non-AP STA of claim 9, wherein the control frame comprises at least one of a trigger frame, a polling frame, or an initial control frame (ICF).

11. The non-AP STA of claim 9, wherein the TXOP is shared among a group of STAs, the group comprising the non-AP STA and at least two additional STAs, including the second STA.

12. The non-AP STA of claim 9, wherein the processor is further configured to:
receive a request to retrieve downlink data from an access point (AP); and
add an additional control frame to a transmit queue to obtain a TXOP for receiving the downlink data.

13. The non-AP STA of claim 9, wherein the processor is further configured to:
determine whether to initiate the TXOP based on a receive (RX) buffer status or link layer (L2) buffer status.

14. The non-AP STA of claim 9, wherein the control frame is transmitted to an additional non-AP STA designated as a group leader, and the group leader is configured to transmit an additional control frame to initiate transmissions with other STAs.

15. The non-AP STA of claim 9, wherein the processor is further configured to:
transfer the TXOP to a group leader STA.

16. The non-AP STA of claim 9, wherein the scheduling information identifies at least one of a transmission timing or resource allocation within the TXOP.

17. A method for wireless communication in a wireless local area network (WLAN), the method comprising:
obtaining, by an access point (AP), access to a wireless medium based on a contention-based channel access procedure;
initiating, by the AP, upon obtaining access to the wireless medium, a transmit opportunity (TXOP);
transmitting, by the AP, a control frame to a group of stations (STAs), the group comprising at least one of another AP, a non-AP STA, or a relay STA; and
coordinating, by the AP, transmissions with the group of STAs during the TXOP based on scheduling information included in the control frame.

18. The method of claim 17, wherein the control frame comprises at least one of a trigger frame, a polling frame, or an initial control frame (ICF).

19. The method of claim 17, wherein the TXOP is shared among the group of STAs for supporting one or more of uplink (UL), downlink (DL), or peer-to-peer (P2P) traffic.

20. The method of claim 17, further comprising:
receiving, by the AP, a request from a non-AP STA for downlink data; and
transmitting, by the AP, the downlink data to the non-AP STA during the TXOP based on the request.
